(19) United States
(12) Patent Application Publication
(10) Pub. No.: US 2008/0112072 A1
(43) Pub. Date: May 15, 2008

(54) Data storage device and data erase method

(75) Inventors: Kiichiro Kasai, Kawasaki (JP); Tomomichi Adachi, Kawasaki (JP); Kimiaki Haga, Kawasaki (JP); Kazunori Sunaga, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/892,931

(22) Filed: Aug. 28, 2007

(30) Foreign Application Priority Data
Nov. 14, 2006 (JP) 2006-307779

(51) Int. Cl. G11B 15/18

(52) U.S. Cl. 360/71

(57) ABSTRACT

A data storage device with a recording medium for which a data erase function unit is introduced to achieve both partial non-erasure of data for analyzing a cause of data error and full erasure of data for protection of personal information. This data erase function unit sequentially performs automatic erasure of data on a hard disk in units of sectors (SC) by turning on a jumper switch, but skips the automatic erasure for any error sector including error among the sectors (SC). For this purpose, it is provided with both an erase unit for full erasure of data and a skip control unit for a partial non-erasure of data.

### BACKGROUND OF THE INVENTION

1. Field of the Invention

The present invention relates to a data storage device, more particularly relates to a data storage device having a built-in data erase function.

2. Description of the Related Art

As is well known, for an information processing apparatus such as a personal computer or work station or a mobile media device such as a video/camera or personal digital assistant (PDA), a data storage device has become an indispensable component. In recent years, further, greater reliability has been demanded for such data storage devices.

These data storage devices are roughly classified into static storage types such as read only memories (ROMs) and random access memories (RAMs) and dynamic storage types such as hard disks and floppy® disks. Each has its merits and demerits, but from the viewpoint of reliability, since dynamic storage type data storage devices include mechanical parts, they are generally more susceptible to error in comparison with the static storage type. Namely, a data storage device using for example a hard disk as a storage medium is more susceptible to error in comparison with the above-described ROMs and RAMs.

When error occurs in a magnetic disk device provided with such a hard disk, i.e., a so-called hard disk drive (HDD), since it is uneconomical to replace the faulty HDD by a normal device, usually that error is corrected and also the cause of occurrence of that error, for example, formation of a minute scratch on the hard disk, is analyzed to apply a countermeasure therefor, and then feedback is given to the design division or production/quality control division to improve the design, production and soon.

As known art relating to the present invention, there are Japanese Patent Publication (A) No. 2005-250700 and Japanese Patent Publication (A) No. 2003-140835.

As an example of the cause of occurrence of error mentioned above, for example a minute scratch on the hard disk was mentioned, but other than this, various causes such as a drop in the level of the read signal and write failure due to impact at the time of the data write operation may be considered.

Therefore, the present invention is characterized by, as will be mentioned later, leaving only the data of an error portion on a recording medium as it is in a faulty data storage device for later examination and analysis of the causes so as to analyze the above cause of error.

On the other hand, the recent rising need for protection of privacy has led to the enactment of laws protecting personal information. As a result, it has become necessary to erase all of the customer information etc. recorded in a data storage device, for example, a recording medium in a faulty HDD, that is, the hard disk, for examining and analyzing the causes of error. This is, the entire erasure of the hard disk.

For such erasure of data of a hard disk, full surface erasure has conventionally been carried out. For example, a conventional “data erasing program” and “HDD unique erase function in HDD” have basically been used for full (full area) erasure. This is true also in the data erase methods disclosed in already mentioned patent publications.

This being the case, the “full erasure” of the basic practice in the past and the “storing only the data in an error portion” (partial non-erasure) contradict each other, so there is the problem that determination of the cause of occurrence of error and the goal of protection of personal information can no longer both be stand at the same time.

### SUMMARY OF THE INVENTION

Accordingly, an object of the present invention is to provide a data storage device and a data erase method able to satisfy both partial non-erasure for analysis of error occurring in a recording medium and full erasure for protection of personal information. Note that the following explanation will be given while taking as a preferred example an HDD (magnetic disk device) including the hard disk as a recording medium.

To attain the above object, the present invention introduces a data erase function unit (5). This data erase function unit sequentially performs automatic erasure of data on a hard disk (4) in units of sectors (SC) by turning on a jumper switch (15), but skips the automatic erasure of any sector including error among the sectors (SC). For this purpose, provision is made of both an erase unit (6) for full erasure of data and a skip control unit (7) for partial non-erasure of data.

### BRIEF DESCRIPTION OF THE DRAWINGS

The above object and features of the present invention will be more apparent from the following description of the preferred embodiments given with reference to the accompanying drawings, wherein:

FIG. 1 is a diagram showing a fundamental configuration of the present invention;

FIG. 2 is a diagram showing an example of the configuration when applying the present invention to an HDD of FIG. 14;

FIG. 3 is a diagram schematically showing a flow of processing in the present invention;

FIG. 4 is a flow chart showing a first mode of processing f shown in FIG. 3;

FIG. 5 is a flow chart showing a second mode of the processing f shown in FIG. 3;

FIG. 6 is a flow chart showing a third mode of the processing f shown in FIG. 3;

FIG. 7 is a flow chart showing a fourth mode of the processing f shown in FIG. 3;

FIG. 8 is a flow chart showing a first mode of not erasing the data up to a recording unit adjacent to an error recording unit;

FIG. 9 is a flow chart showing a second mode of not erasing data up to a recording unit adjacent to an error recording unit;

FIG. 10 is a flow chart showing a first example in which the adjacent recording unit is also not erased;

FIG. 11 is a flow chart showing a second example in which the adjacent recording unit is also not erased;

FIG. 12 is a flow chart showing a third example in which the adjacent recording unit is also not erased;

FIG. 13 is a flow chart showing a fourth example in which the adjacent recording unit is also not erased;

FIG. 14 is a diagram showing an example of the configuration of a known HDD to which the present invention is applied; and

FIG. 15 is a diagram showing an example of a known configuration of a hard disk and its peripheral portion.

### DESCRIPTION OF THE PREFERRED EMBODIMENTS

Preferred embodiments of the present invention will be described in detail below while referring to the attached figures.

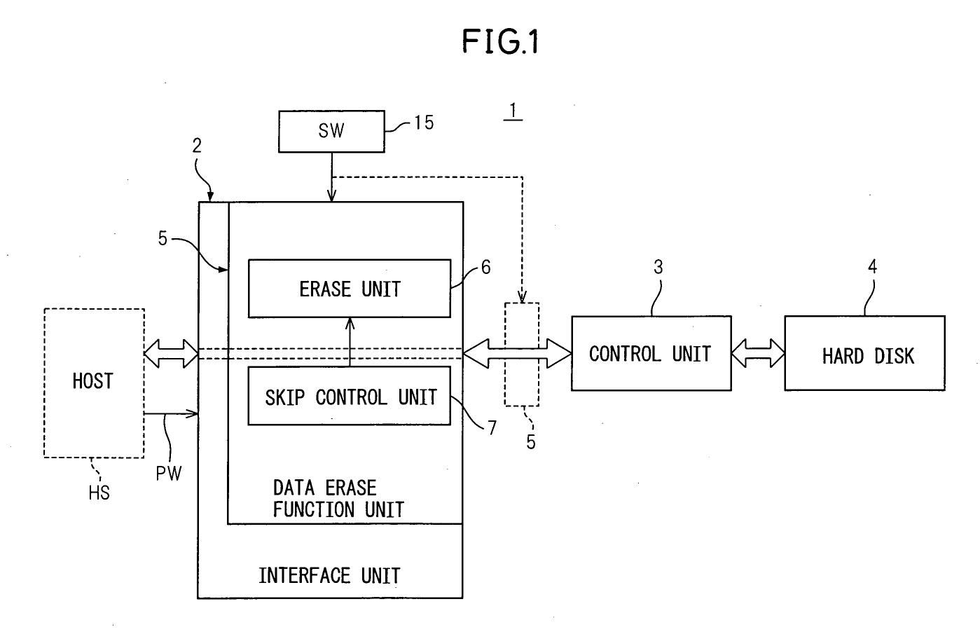

FIG. 1 is a diagram showing a fundamental configuration of the present invention. In the figure, reference numeral 1 indicates an HDD (data storage device). The known major components of this HDD1 are indicated by reference numerals 2, 3, and 4.

A hard disk (recording medium) 4 stores data to be written and read out. A control unit 3 controls the writing and reading of data to and from the hard disk (recording medium) 4. This control unit 3 can be a data channel unit as an example. An interface unit 2 performs interface control between the control unit 3 and a host HS instructing the above-described write and read control to this control unit 3. Other than this, it also performs analysis of a host command and instructs a write operation, instructs a read operation, etc. to the hard disk 4. It is configured by an MPU and a hard disk controller (HDC).

In such an HDD (data storage device) 1, the components characterizing the present invention are indicated by reference numerals 5, 6, and 7. Namely, the HDD 1 is provided with a data erase function unit 5 having a function of erasing the data recorded on the hard disk 4. Here, the data erase function unit 5 is characterized in that it includes an erase unit 6 for sequentially erasing the data recorded on the hard disk 4 for each predetermined recording unit and a skip control unit 7 for designating the erase unit 6 to skip the erasure for a recording unit including an error among a plurality of sectors. Thus, recording units including error can be selectively determined for non-erasure while executing the full erasure. Note that, as an example of the above-described “recording unit”, there is a “sector”. Below, this will be referred to as a “sector”.

The above-described data erase function unit 5 may be integrally formed in the interface unit 2 as shown in FIG. 1 or may be formed in the vicinity thereof as indicated by a dotted line block 5 of FIG. 1. Further, the HDD 1 is preferably driven only by power supplied from the host HS (see power line PW of FIG. 1).

As effects of the present invention, first, partial non-erasure of data for the analysis of the cause of occurrence of error and full erasure for protection of personal information can be simultaneously achieved.

Second, the partial non-erasure and full erasure can be executed by an HDD alone, therefore can be easily executed without instructions from a dedicated special device or host controller or without utilizing the system of the user. In this case, it is sufficient to use power only for executing that. In addition, this power can be easily secured from a cooperating host HS side.

Third, the above-described partial non-erasure and full erasure can be carried out without introduction of any special equipment and in a short time.

Fourth, as described above, since operation by an HDD alone is possible, this operation can be freely executed at any time without being influenced by conditions on the host side.

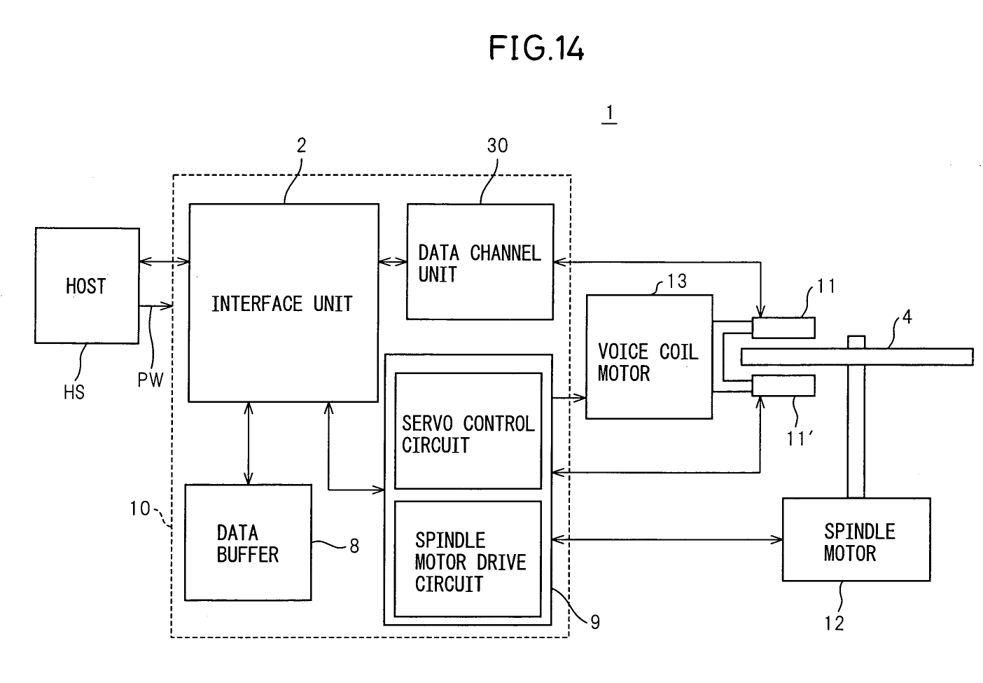

FIG. 14 is a diagram showing a conventional HDD to which the present invention may be applied. Note that, throughout all the drawings, the same components are indicated by the same reference numerals or symbols. Accordingly, the interface unit 2, the control unit, and the hard disk 4 in the HDD 1 linked with the host HS are as explained before. Note that the aforesaid control unit 3 is shown as for example a data channel unit 30 in the present figure.

A spindle motor 12 rotates the hard disk 4 at a high speed, and a voice coil motor 13 moves magnetic heads 11 and 11′ while maintaining very small gaps between these and the hard disk 4. The head 11 is used for the writing and reading the data, while the head 11′ is used for servo control for positioning the head 11 at a predetermined track.

The above-described motor 12 and motor 13 are driven under the control of a spindle motor drive circuit and a servo control circuit in the servo control unit 9. This servo control unit 9 communicates drive control information with the interface unit 2. This interface unit 2 further cooperates with a data buffer 8. This data buffer 8 is used for temporary storage of various types of parameters, control information, etc. Note that the above-described components 2, 30, 8, and 9 are usually mounted on a circuit board 10 all together.

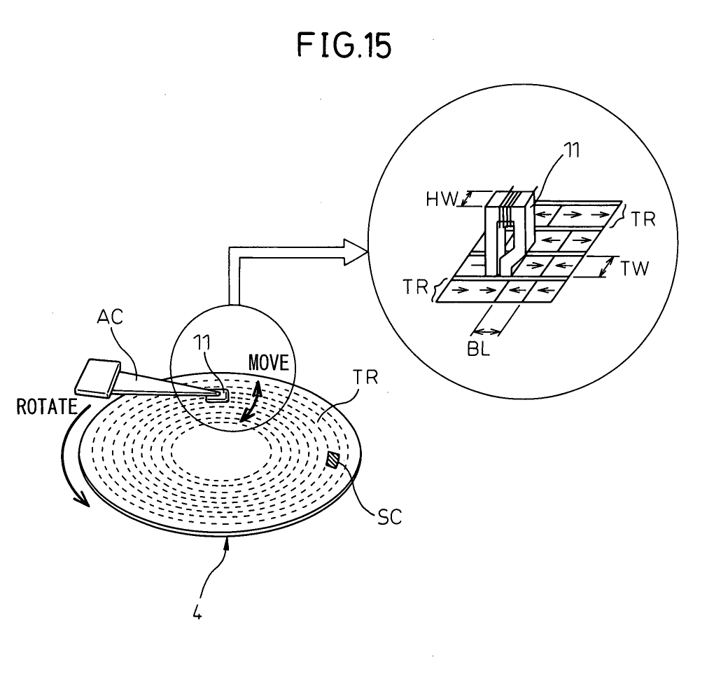

FIG. 15 is a diagram showing an example of the general configuration of the hard disk 4 and its peripheral portion. In the figure, the magnetic head 11 floating on the hard disk 4 rotating at a high speed is moved by an actuator AC in a direction indicated by a bidirectional arrow shown in the diagram and positioned on an indicated track TR by this movement. In each track TR, a plurality of sectors SC each consisting of for example 512 bytes are arranged in a line. The track width thereof is indicated as TW. Note that, BL is a bit length, and HW is a head width.

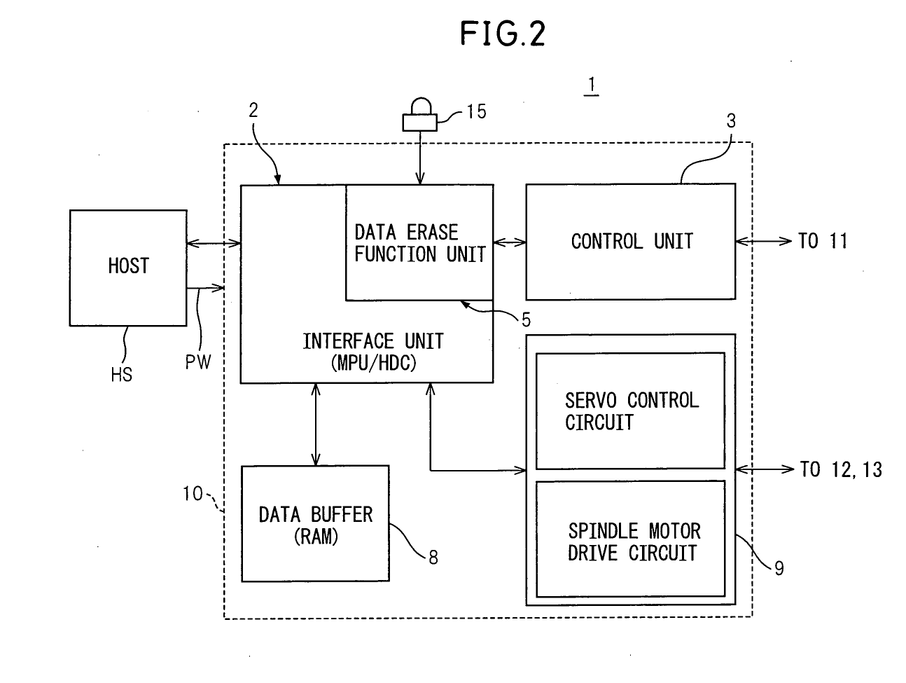

FIG. 2 is a diagram showing an example of the configuration when applying the present invention to the HDD of FIG. 14. In the interface unit 2 of FIG. 14, the data erase function unit 5 shown in FIG. 1 is introduced. Further, an external switch (SW) shown in FIG. 1 is indicated as a jumper switch 15.

By connecting the jumper switch (external switch) 15, which is provided in the HDD (data storage device) 1 and can be manually operated, to the data erase function unit 5 and turning on the jumper switch 15, a command from the data erase function unit 5 is given a higher priority than a command from the host HS to drive both the control unit 3 and the servo control unit 9 is made possible. Due to this, the aforesaid partial non-erasure and full erasure can be completed freely and in a short time by the HDD alone, that is, without another special device, so far as there is just a power supply.

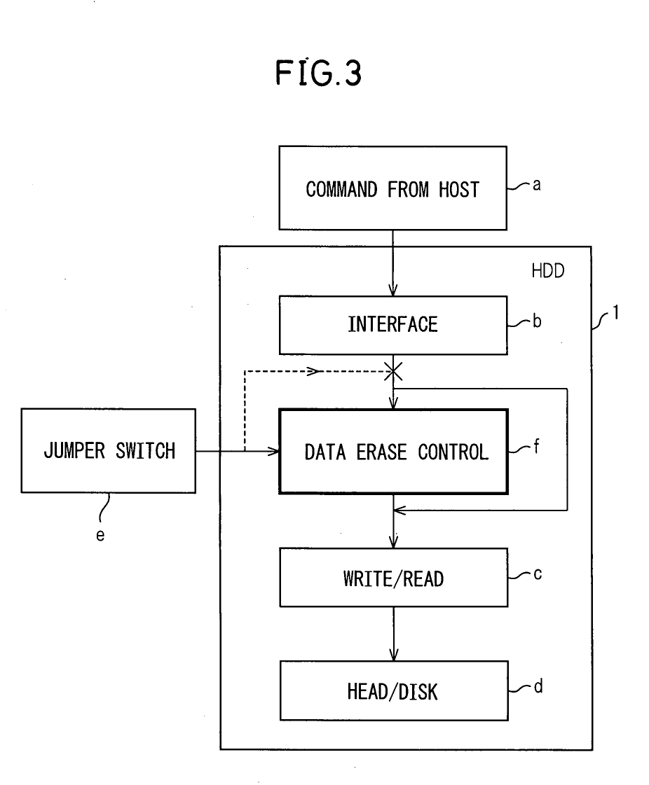

FIG. 3 is a diagram schematically showing the flow of the above-mentioned processing in the present invention. In the figure, the flow of processing at the time of the normal operation is a→b→c→d. Namely, according to a command from the host HS (a), the interface unit 2 starts the write/read control (b), the control unit 3 and the servo control unit 9 execute actual write/read operations according to this control (c), and the writing/reading of the data with respect to the hard disk 4 by the magnetic head 11 (11′) is carried out (d).

In the flow of such general processing, at the time of operations of full erasure+partial non-erasure according to the present invention, the above-described flow of processing becomes e→f→c→d. Namely, when the jumper switch 15 is turned on by manual operation, the flow b→c of the usual processing is shut off at a mark x in the figure (e), the data erase control of full erasure, including partial non-erasure of data, is started (f), then a flow the same as the flow c→d of processing mentioned before continues.

Note that in FIG. 3, the processing b and f are drawn completely separated, but strictly speaking the processing f is carried out by borrowing the already mentioned functions of MPU and HDC in the interface unit 2. Below, a concrete example of this processing f will be explained.

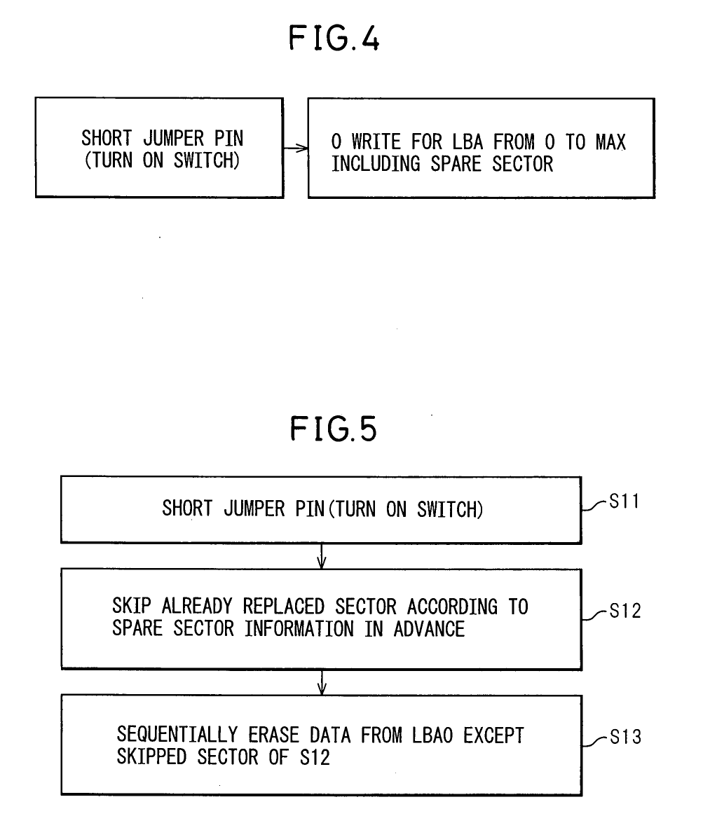

FIG. 4 is a flow chart showing a first mode of the processing f in FIG. 3. This first mode is based on the full erasure of the present invention. Accordingly, it does not include the partial non-erasure of the present invention. When a jumper pin is shorted, that is, when the above-described jumper switch is turned on, the writing of data 0 (0 write), that is, the erasure, is executed from LBA-0 to LBA-MAX of the logical block addresses (LBA) for specifying a series of sectors SC. At this time, because of execution of the full erasure, a spare sector replacing the sector causing writing or reading trouble is also written in by an 0 write.

FIG. 5 is a flow chart showing a second mode of the processing f shown in FIG. 3. This second mode is, in summary, a mode where the skip control unit 7 of FIG. 1 designates a sector SC including error as a sector to be skipped (partial non-erasure) with reference to the error information concerning the error registered at the time of the use of the related HDD 1. The “error information” referred to here is for example the above-mentioned replaced spare sector information.

As a concrete example of operation, in FIG. 5,

Step S11: The jumper pin is shorted (the switch 15 is turned ON), and

Step S12: the sector which is already replaced according to the above-mentioned spare sector information, that is, the error sector, is determined as a sector to be skipped in advance.

Step S13: The full erasure (0 write) of the data is carried out from LBA0 except the sector SC determined to be skipped in step S12 described above.

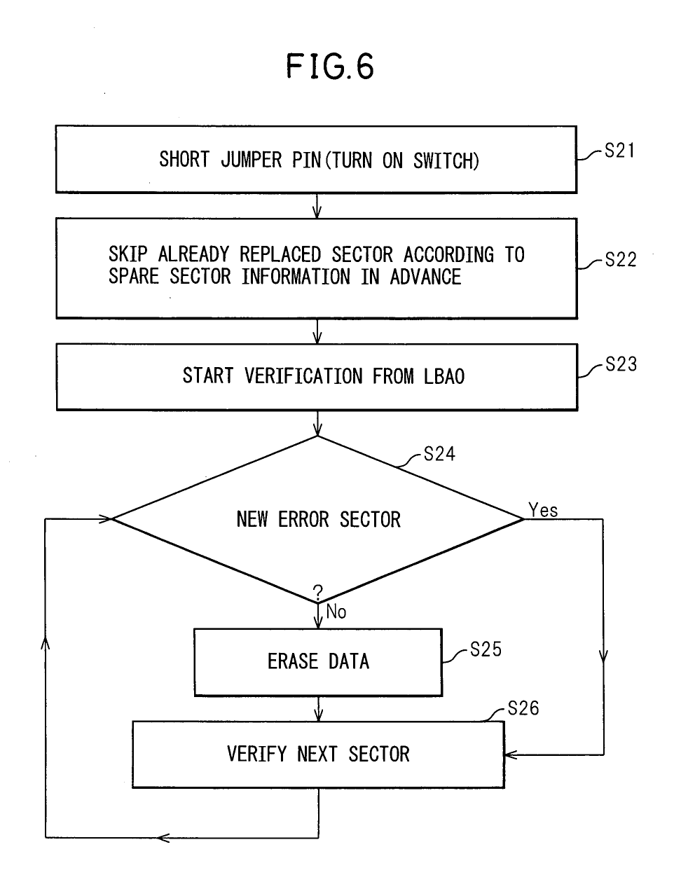

FIG. 6 is a flow chart showing a third mode of the processing f shown in FIG. 3. This third mode is, in summary, a mode where the skip control unit 7 of FIG. 1 sequentially executes a verification operation every time before execution of erasure of the sectors SC from the first sector SC and designating any sector including error newly detected by that verification as a sector to be skipped (partial non-erasure).

Step S21: Same as step S11 of FIG. 5.

Step S22: Same as step S12 of FIG. 5.

Step S23: The verification is started from LBA0. This is for checking if any sector newly became an error sector for a certain reason after that. Note that the above-described verification can be carried out by the control unit 3 by using for example an error correction code (ECC).

Step S24: When it is judged by the above-described verification that no sector became a new error sector (No),

Step S25: the data erasing is executed, and

Step S26: next, the routine shifts to the sector to be verified next, that is, the sector which does not become a sector to be skipped, and it is judged if any sector becomes a new error sector again. Further, when it is clarified in the above-described step S24 that a sector becomes a new error sector (Yes), the data of that sector is not erased at this time, but the routine enters into the present step S26, where the next sector is verified.

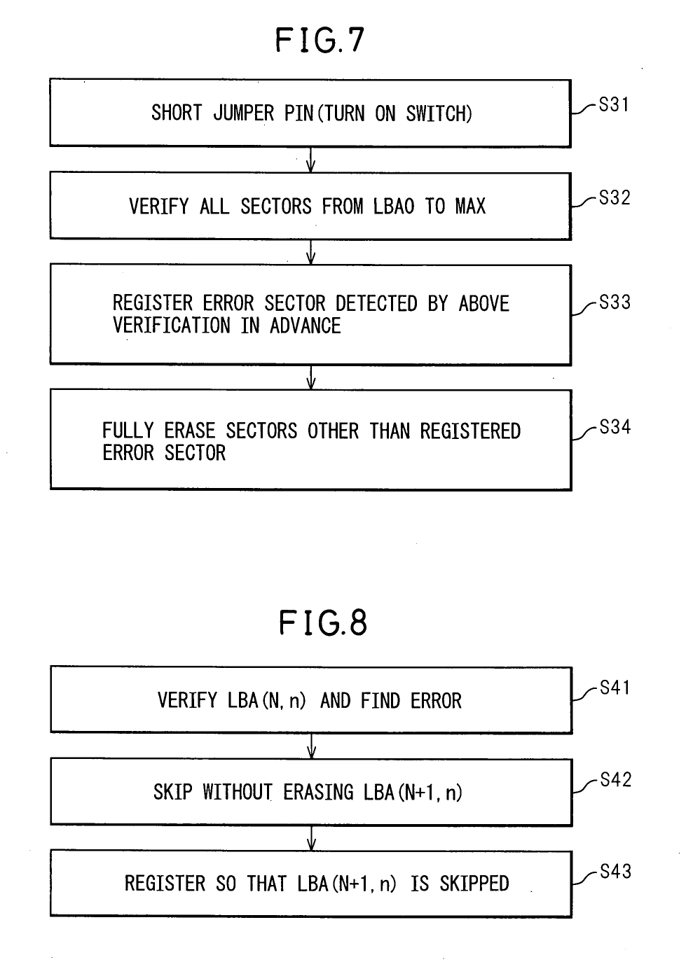

FIG. 7 is a flow chart showing a fourth mode of the processing f shown in FIG. 3. This fourth mode is, in summary, a mode where the skip control unit 7 of FIG. 1 executes full verification of the hard disk (recording medium) 4 before starting the automatic erasure by the automatic erase unit 6 of FIG. 1, acquires error information concerning error detected by this, and designates any sector including that error as the aforesaid sector to be skipped (partial non-erasure).

As a concrete example of operation, in FIG. 7,

Step S31: same as S21 of FIG. 6.

Step S32: The verification is carried out with respect to all sectors (including also the replaced sector) from LBA0 to MAX of LBA.

Step S33: The error sector detected by the above-described verification is registered in advance preceding the start of the data erasure. It is registered in a table formed in for example the data buffer (RAM) 8 of FIG. 2.

Step S34: Here, the inherent full erasure of data is started. Note that any error sector registered in the table is set aside for partial non-erasure and its data is not erased.

In the above explanation, processing is performed so as not to erase the data of only an error sector in which error is detected by the above-described verification. However, considering that error, if that error occurred due to for example a scratch, that scratch may influence an adjacent sector. However, if the influence of that scratch is small, merely the read out signal level from that adjacent sector is slightly lowered (reduced in level). In this case, that adjacent sector sometimes becomes a pseudo normal sector which is not in itself judged as an error sector.

Therefore, it is advisable that this pseudo normal sector also be handled as a sector for error analysis, and the data not be erased.

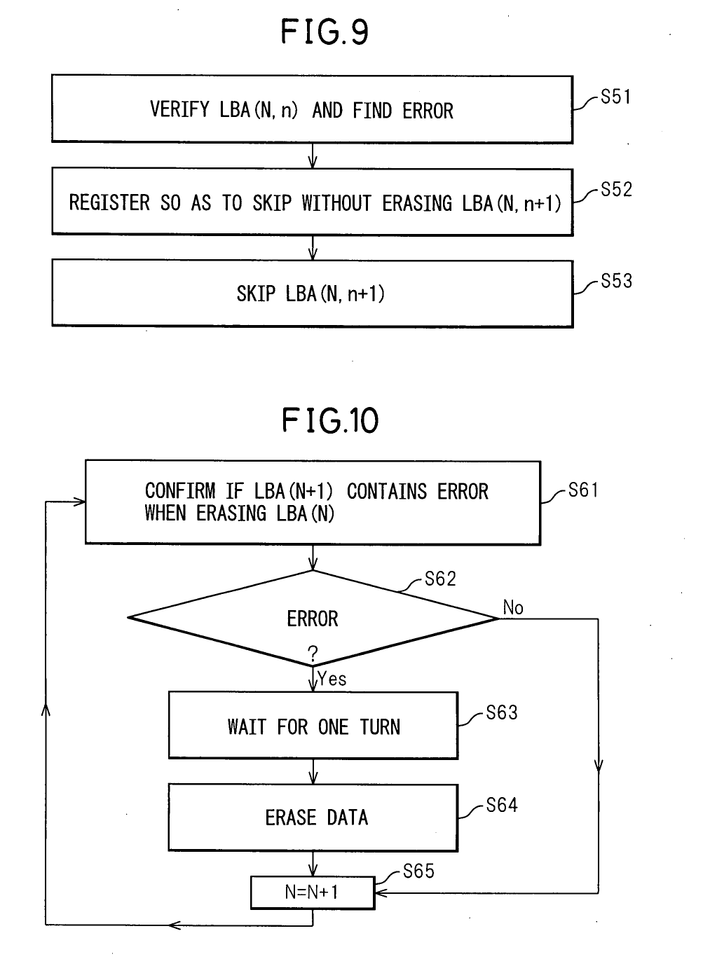

FIG. 8 is a flow chart showing a first mode of not erasing the data of a recording unit adjacent to an error recording unit as well; and FIG. 9 is a flow chart showing a second mode thereof.

In FIG. 8,

Step S41: it is assumed that an LBA (N, n) is verified, and the error is detected. Note that “LBA (N, n)” means a sector of LBA (N) on an n-th track.

Step S42: The sector of LBA (N+1, n) on the same track as that LBA (N, n) and adjacent to the LBA (N, n) in the forward direction thereof is registered in for example the data buffer 8 of FIG. 2, and

Step S43: the adjacent sector of that LBA (N+1, n) is skipped (data non-erasure).

In FIG. 9,

Step S51: same as step S41 of FIG. 8.

Step S52: An adjacent sector LBA (N, n+1) existing on a track (n+1) adjacent to a track (n) in which LBA (N, n) exists is registered in for example the above-described data buffer 8 as a non-erasure sector, and

Step S53: the adjacent sector (N) on that adjacent track (n+1) is not erased.

(A) In FIG. 8 described above, the mode determining a sector adjacent to the error sector in its forward direction for data non-erasure was shown, but also a sector adjacent to that error sector in its backward direction may also be determined for data non-erasure.

(B) In the same way, in FIG. 9 described above, the mode determining the adjacent sector existing on a left side track of the track in which the error sector existed as the data non-erasure was shown, but also an adjacent sector existing on a track adjacent on the right side to the track in which that error sector exists may be determined as the data non-erasure.

Summarizing the above description all together, concerning (A) described above, in addition to the skipping of the sector SC including an error, at least one sector between sectors adjacent to this error sector in its forward and backward directions may also be designated as a sector to be skipped mentioned before. Further, concerning (B) described above, in addition to the skipping of the sector SC including an error, an adjacent sector arranged on at least one track between tracks adjacent on the left side and right side to the track in which this error sector is located may be designated as a sector to be skipped.

Below, an example of two or three sequences designating adjacent sectors as sectors for non-erasure of data in addition to the error sector will be shown.

FIG. 10 is a flow chart showing a first example of designating an adjacent sector for non-erasure of data. In the figure,

Step S61: when erasing an N-th sector of LBA, this is not immediately erased, but it is confirmed if the data of a sector of NBA (N+1) adjacent to that on its forward side contains error. When this LBA (N+1) contains error, a process of designating the LBA (N) for non-erasure of data is started.

Step S62: The presence/absence of error described above is judged,

Step S63: when an error exists (Yes), one turn of the disk 4 until the original sector LBA (N) is returned to again is awaited, then

Step S64: the sector of LBA (N) is erased, and

Step S65: the routine shifts to the verification of the next sector. Further, also at the time when step S62 is No, the routine shifts to the present step S56.

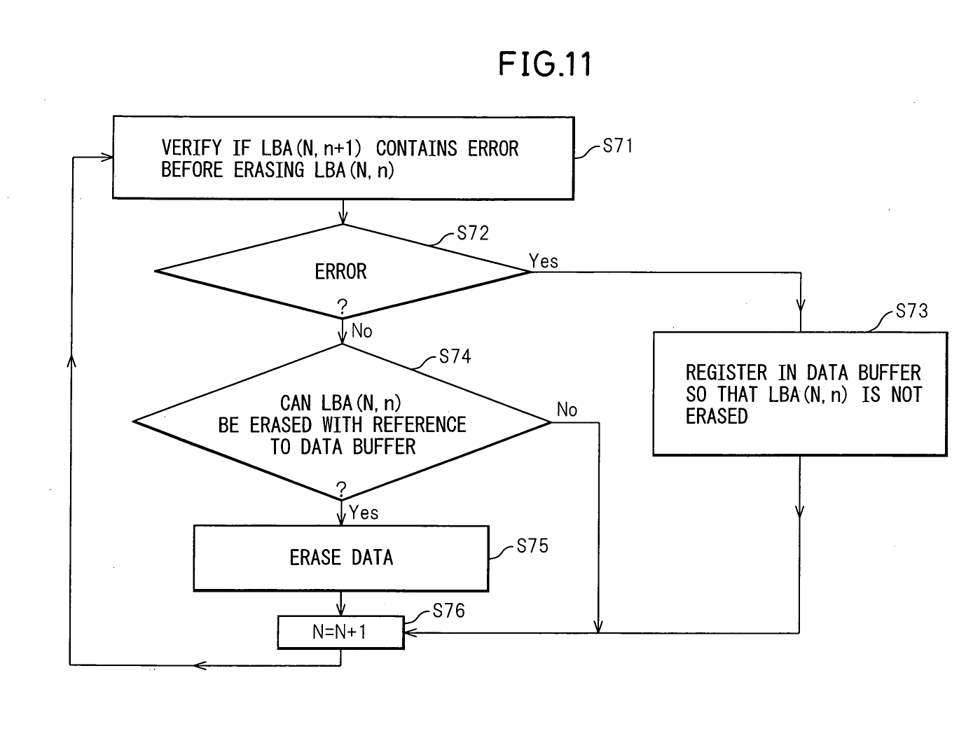

FIG. 11 is a flow chart showing a second example of designating an adjacent sector for non-erasure of data. In the figure,

Step S71: before erasing the sector of LBA (N, n) existing on the n-th track, it is verified if a sector of LBA (N, n+1) adjacent to that sector on its adjacent track (n+1) contains error. When the LBA (N, n+1) contains error, a process of designating the LBA (N, n) for non-erasure of data is started.

Step S72: It is confirmed if the LBA (N, n+1) contains error, and when it contains error (Yes),

Step S73: this fact is registered in the data buffer 8 so as not to erase the data of that sector LBA (N, n).

Step S74: When the LBA (N, n+1) does not contain error in step S72 described above (No), it is judged if the LBA (N, n) can be erased with reference to the data buffer 8,

Step S75: when that judgment is Yes, the data of the LBA (N, n) is erased, and

Step S76: the routine shifts to the verification of the next sector.

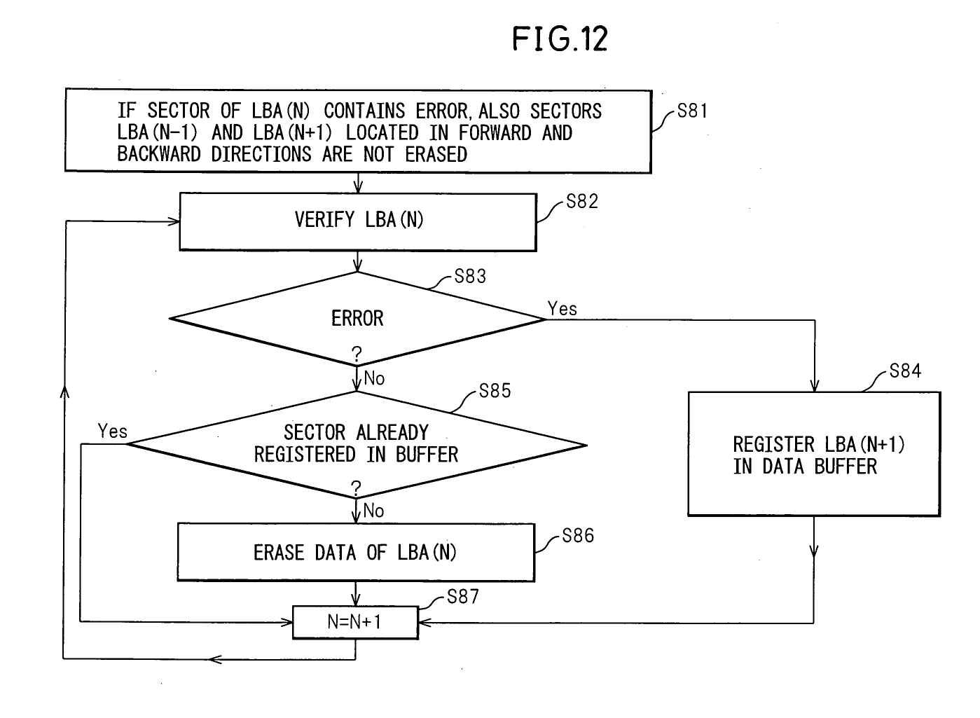

FIG. 12 is a flow chart showing a third example of designating an adjacent sector for non-erasure of data. In the figure,

Step S81: if the sector of LBA (N) contains error, a skip process is started so as not to erase the data of both of the sector (N+1) adjacent to the error sector in its forward direction and the sector (N−1) adjacent to the error sector in its backward direction.

Step S82: The verification is started for the sector of LBA (N),

Step S83: it is judged if that LBA (N) contains error, and

Step S84: when it contains error (Yes), the adjacent LBA (N+1) thereof is registered in the data buffer 8.

Step S85: When it is judged in the above-described step S83 that there is no error (No), it is judged if the sector LBA (N) is a sector already registered in the data buffer 8,

Step S86: If it is not already registered (No), the above-described sector LBA (N) is erased, and

Step S87: the routine shifts to the next sector. Even at the time of Yes in step S85, the routine shifts to the present step S87.

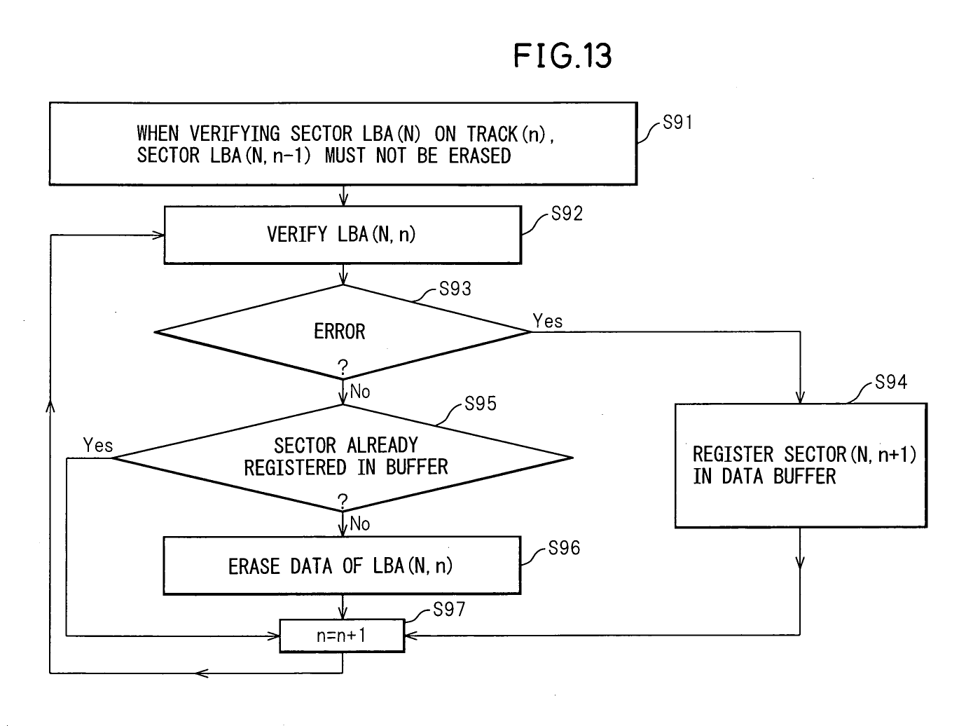

FIG. 13 is a flow chart showing a fourth example of designating an adjacent sector for non-erasure of data. In the figure,

Step S91: when verifying the sector LBA (N, n) on the track (n), a skip process is started so as not to erase the data of a sector LBA (N, n−1) adjacent on its adjacent track (n−1).

Step S92: The verification of the sector LBA (N, n) is started,

Step S93: it is judged if an error exists in the LBA (N, n), and

Step S94: If error exists (Yes), the sector LBA (N, n+1) on the adjacent track (n+1) is registered in the data buffer 8.

Step S95: When it is judged in the above-described step S93 that error does not exist (No), it is judged if the sector LBA (N, n+1) is a sector already registered in the data buffer 8,

Step S96: If it is not already registered (No), the data of the above-described sector LBA (N, n) is erased, and

Step S97: the routine shifts to the next sector. Also at the time of No in step S95, the routine shifts to the present step S97.

Finally, summarizing the HDD (data storage device) of the present invention explained above from the viewpoint of the data erase method, this data erase method is a data erase method in an HDD 1 having at least a hard disk 4 and write/read function portions (2, 3) for performing the writing and reading to and from the hard disk 4. The principal steps thereof are the erasing step of sequentially performing the full erasure of the data recorded on the hard disk 4 in units of sectors and a step inserted into the above-described erasing steps from time to time to skip an error sector including error among sectors SC without erasing data.

In this case, a step of referring to sectors already registered in the HDD 1 as sectors SC including error is provided. These can be made as the above-mentioned error sectors.

Further, in the above-described erasing step, verification of the sector SC is carried out every time before erasing each sector SC so as to detect any new error sector. In the above-described skip step, the newly detected error sector can therefore also be skipped.

Further, preceding the above-described erasing step, full verification of the hard disk 4 is executed so as to detect any error sector. In the above-described skip step, any error sector detected by the full verification can therefore be skipped.

Note that, when the jumper switch 15 which can be manually operated is turned on, the above-described erasing step and skip step are activated.

While the invention has been described with reference to specific embodiments chosen for purpose of illustration, it should be apparent that numerous modifications could be made thereto by those skilled in the art without departing from the basic concept and scope of the invention.

What is claimed is:

1. A data storage device comprising
a storage medium for storing data to be written and read out and
a control unit for controlling the writing and reading of the data to and from said recording medium, wherein
provision is made of a data erase function unit having a function of erasing the data recorded in said recording medium, the data erase function unit being configured by an erase unit for sequentially erasing the data recorded in said recording medium for each predetermined recording unit and a skip control unit for designating said erase unit to skip said erasing for a recording unit including error among a plurality of said recording units.

2. A data storage device as set forth in claim 1, wherein said skip control unit designates a recording unit including error as a unit to be skipped with reference to error information concerning said error registered at the time of use of the data storage device.

3. A data storage device as set forth in claim 2, wherein said skip control unit sequentially executes verification from a first recording unit every time before erasing recording units and designates also any recording unit including error newly detected by that verification as a unit to be skipped.

4. A data storage device as set forth in claim 1, wherein said skip control unit executes full verification with respect to said recording medium before starting automatic erasure by said automatic erase unit, acquires error information concerning error detected by this, and designates any recording unit including error as said unit to be skipped.

5. A data storage device as set forth in claim 1, wherein in addition to a recording unit including error, also at least one recording unit between recording units adjacent to this error recording unit in its forward and backward directions is designated as a unit to be skipped.

6. A data storage device as set forth in claim 1, wherein in addition to a recording unit including error, also an adjacent recording unit located on at least one track between tracks adjacent on the left side and right side to the track in which this error recording unit is located is designated as a unit to be skipped.

7. A data storage device as set forth in claim 1, wherein
said data erase function unit is connected to an external switch which is provided in the data storage device and can be manually operated, and
a command from said data erase function unit is given a higher priority than a command from said host by turning on the external switch.

8. A data storage device as set forth in claim 1, wherein the device is driven only by a supply of power from said host.

9. A data storage device as set forth in claim 1, wherein said data erase function unit is formed integrally in said interface unit or in the vicinity thereof.

10. A data storage device as set forth in claim 1, wherein provision is further made of
a control unit,
a host for instructing said write and read control with respect to the control unit, and
an interface unit for performing interface control between said control unit and host.

11. A data erase method in a data storage device having at least a recording medium and write/read control portions for performing writing and reading to and from the recording medium, comprising:
an erasing step of sequentially performing full erasure of data recorded in said recording medium for each recording unit and
a skip step inserted into said erasing step from time to time to skip any recording unit including error among said recording units without performing said erasing.

12. A data erase method as set forth in claim 10, wherein further comprising a step of referring to recording units already registered in said data storage device as recording units including error so as to designate said error recording units.

13. A data erase method as set forth in claim 11, wherein said erasing step includes a step of performing verification of each recording unit every time before erasing said recording units and, in said skip step, any newly detected error recording unit is also skipped.

14. A data erase method as set forth in claim 11, further having a step of executing full verification of said recording units preceding said erasing step to detect any error recording unit, and, in said skip step, skipping the error recording unit detected by said full verification.

15. A data erase method as set forth in claim 11, wherein an external switch which can be manually operated is turned on to activate said erasing step and said skip step.

16. A computer readable medium having a program stored therein to cause erasure of data in a data storage device having at least a recording medium and write/read function units for performing the writing and reading to and from the recording medium, whereby:
the data recorded in said recording medium is sequentially fully erased for each recording unit, and
at any time during said full erasure, a recording unit including error among said recording units inserted is skipped without being erased.

17. A computer readable medium having a program stored therein as set forth in claim 16, wherein recording units already registered in said data storage device as recording units including error are referred to so as to designate said error recording units.
